(19) United States
(12) Patent Application Publication
(10) Pub. No.: US 2025/0301048 A1
(43) Pub. Date: Sep. 25, 2025

(54) PAGE PROCESSING METHOD, DEVICE, AND STORAGE MEDIUM

(71) Applicant: Beijing Youzhuju Network Technology Co., Ltd., Beijing (CN)

(72) Inventor: Li JIA, Beijing (CN)

(21) Appl. No.: 19/087,400

(22) Filed: Mar. 21, 2025

(30) Foreign Application Priority Data
Mar. 21, 2024 (CN) 202410330774.4

(51) Int. Cl. H04L 67/53; H04L 67/02

(52) U.S. Cl. CPC H04L 67/53; H04L 67/02

(57) ABSTRACT

A page processing method, a device and a storage medium are provided. The method includes: acquiring initial service information of a target service input based on a preset service entry page, where the preset service entry page includes a preset service element corresponding to the target service type, and the initial service information includes an element content corresponding to the preset service element; performing information detection on the initial service information, and when a detection result of the initial service information is passing, creating at least one initial service page according to the initial service information; and performing page style detection on the at least one initial service page, and when the detection is passed, determining at least one initial service page as a target service page corresponding to the target service and used for being displayed in a preset network platform.

### CROSS-REFERENCE TO RELATED APPLICATION

The present application claims priority of the Chinese Patent Application No. 202410330774.4, filed on Mar. 21, 2024, the disclosure of which is incorporated herein by reference in its entirety as part of the present application.

### TECHNICAL FIELD

Embodiments of the present disclosure relate to a page processing method and apparatus, a device and a storage medium.

### BACKGROUND

With the rapid development of information technology and the popularization of mobile Internet, users can acquire various services through various Internet-related functions, such as a photography service, a decoration service, a housekeeping service, or a product purchase service, which provides a great convenience for various aspects of the users' life and work.

At present, a service provider may provide services to users by publishing service information in various network platforms. Specifically, the service page including the service information may be developed to be displayed in the network platform, and before displaying the service page to the users, the network platform needs to detect the service information and the page style in the service page. However, the current process of page development and page detection is inefficient and needs to be improved.

### SUMMARY

Embodiments of the present disclosure provide a page processing method and apparatus, a device and a storage medium, which can optimize an existing page processing solution for a service page.

The embodiments of the present disclosure provide a page processing method, which includes:
acquiring initial service information of a target service input based on a preset service entry page, where the preset service entry page includes a preset service element corresponding to a target service type, a type of the target service is the target service type, and the initial service information includes an element content corresponding to the preset service element;
performing information detection on the initial service information, and when a detection result of the initial service information is passing, creating at least one initial service page according to the initial service information; and
performing page style detection on the at least one initial service page, and determining an initial service page of which a detection result is passing, in the at least one initial service page, as a target service page corresponding to the target service, wherein the target service page is a page used for being displayed in a preset network platform.

The embodiments of the present disclosure further provide a page processing apparatus, which includes an initial service information acquiring module, an initial service page creating module and a target service page determining module.

The initial service information acquiring module is configured to acquire initial service information of a target service input based on a preset service entry page, where the preset service entry page includes a preset service element corresponding to a target service type, a type of the target service is the target service type, and the initial service information includes an element content corresponding to the preset service element.

The initial service page creating module is configured to perform information detection on the initial service information, and when a detection result of the initial service information is passing, create at least one initial service page according to the initial service information.

The target service page determining module is configured to perform page style detection on the at least one initial service page, and determine an initial service page of which a detection result is passing, in the at least one initial service page, as a target service page corresponding to the target service, wherein the target service page is a page used for being displayed in a preset network platform.

The embodiments of the present disclosure further provide an electronic device, and the electronic device includes one or more processors and a memory. The memory is configured to store one or more programs. When the one or more programs are executed by the one or more processors, the one or more processors is caused to implement the page processing method provided by the embodiments of the present disclosure.

The embodiments of the present disclosure further provide a storage medium, which includes computer-executable instructions. When the computer-executable instructions are executed by a computer processor, the computer-executable instructions are used for executing the page processing method provided by the embodiments of the present disclosure.

### BRIEF DESCRIPTION OF DRAWINGS

The above and other features, advantages, and aspects of the embodiments of the present disclosure become more apparent with reference to the following specific embodiments and in combination with the drawings. In the drawings, the same or similar reference numbers refer to the same or similar elements. It should be understood that the drawings are schematic, and the components and elements are not necessarily drawn to scale.

FIG. 1 is a flowchart of a page processing method provided by an embodiment of the present disclosure;

FIG. 2 is a flowchart of another page processing method provided by an embodiment of the present disclosure;

FIG. 3 is a schematic diagram of service modeling provided by an embodiment of the present disclosure;

FIG. 4 is a schematic diagram of a state machine provided by an embodiment of the present disclosure;

FIG. 5 is a structural diagram of a page processing apparatus provided by an embodiment of the present disclosure; and

FIG. 6 is a structural diagram of an electronic device provided by an embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms, and should not be interpreted as being limited to the embodiments set forth herein. On the contrary, these embodiments are provided for a more thorough and complete understanding of the. It should be understood that the drawings and embodiments of the present disclosure are only for exemplary purposes and are not intended to limit the protection scope of the present disclosure.

It should be understood that the various steps described in the method implementations of the present disclosure may be performed in different orders and/or in parallel. Furthermore, the method implementations may include additional steps and/or omit performing the illustrated steps. The scope of the present disclosure is not limited in this respect.

The term “include” and its variants used herein are open-ended inclusions, i.e., “include but not limited to”. The term “based on” is “based, at least in part, on”. The term “one embodiment” means “at least one embodiment”; the term “another embodiment” means “at least one additional embodiment”; the term “some embodiments” means “at least some embodiments”. Relevant definitions of other terms will be given in the description below.

It should be noted that concepts such as “first” and “second” mentioned in the present disclosure are only used to distinguish between different apparatuses, modules or units, and are not used to limit the order or interdependence of functions performed by these apparatuses, modules or units.

It should be noted that the modifications of “one” and “a plurality of” mentioned in the present disclosure are illustrative rather than restrictive, and those skilled in the art should understand that they should be understood as “one or more” unless the context clearly indicates otherwise.

It can be understood that data (including but not limited to the data itself, the acquisition or use of the data) involved in the technical solution of the present disclosure shall comply with requirements of corresponding laws and regulations and related provisions.

In order to facilitate understanding of the technical solutions of the embodiments of the present disclosure, the related art is introduced below. In the related art, a service provider can develop a service page that includes service information and is used for being displayed in a network platform. The network platform needs to be responsible for the displayed page. Therefore, before displaying the service page to a user, the service page is required to be detected, and the service page can be displayed to the user only after passing the detection. When detecting the service page, machine and/or manual detection may be performed. Two main aspects of the detection include the detection of the service information and the detection of the page style. In the case of the first detection and a change in the service page, a comprehensive detection needs to be performed, the comprehensive detection has high cost and poor timeliness. Especially when the service provider develops a plurality of service pages for the same service, the detection cost will increase significantly, which seriously affects the timeliness of displaying the service page.

In the embodiments of the present disclosure, the service information detection and the page style detection for the service page used for being displayed in the preset network platform are separated, so that the detection for the service page can be more flexible and efficient.

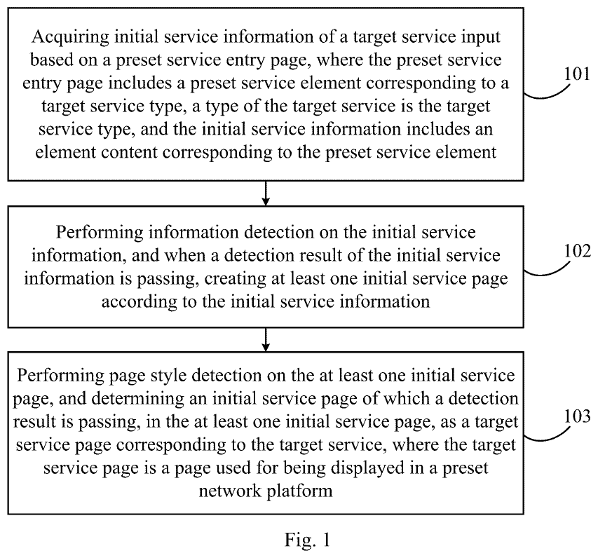

FIG. 1 is a flowchart of a page processing method provided by an embodiment of the present disclosure. The embodiments of the present disclosure are applicable to a scenario of performing page processing on a service page. The method may be performed by a page processing apparatus, and the apparatus may be implemented in the form of software and/or hardware. Optionally, the apparatus may be implemented by an electronic device, and the electronic device may be a mobile terminal such as a mobile phone, a smart watch, a tablet computer and a personal digital assistant, or may be a device such as a personal computer (PC) or a server.

As shown in FIG. 1, the method includes the following steps.

Step 101: acquiring initial service information of a target service input based on a preset service entry page, where the preset service entry page includes a preset service element corresponding to a target service type, a type of the target service is the target service type, and the initial service information includes an element content corresponding to the preset service element.

In the embodiments of the present disclosure, the specific platform type of the preset network platform is not limited, for example, the preset network platform may be at least one of a media content publishing platform, an e-commerce platform, a social platform and an information platform. For example, the preset network platform may be a platform that has a media publishing function, an e-commerce function, and a social function at the same time. The electronic device may specifically be a device corresponding to the preset network platform, such as a server-side device of the preset network platform.

Exemplarily, the service information may include information related to a service attribute, which may be used as a material in the service page. Optionally, services that can be provided on the preset network platform may be classified in advance, and a specific classification manner is not limited. For example, the services may be classified based on an industry to which the services belong, so as to obtain a plurality of service types. For each service type, a basic constituent element of a service corresponding to the service type may be predefined and recorded as a preset service element. The preset service element may be set according to an actual situation, which is not specifically limited, for example, the preset service element may be determined according to a service attribute of the service type. Taking the service type being a photography service as an example, the preset service elements may include service images, package names, package prices, shooting cities, the number of shots, the number of clothing sets, and the like.

Exemplarily, the target service may be understood as a service of a corresponding service page that currently needs to be determined, and the target service type is the service type of the target service, which may be a specific one of the plurality of service types obtained after the service classification is performed.

Exemplarily, the preset service entry page may be a page oriented to a service provider that provides the target service, and may be a page displayed on a device on a service provider side, for example, may be a page in a preset application installed on the device on the service provider side, or a webpage displayed on the device on the service provider side. A related person of the service provider (hereinafter referred to as the service provider for convenience of description) may access the preset service entry page. The preset service entry page includes the preset service element corresponding to the target service type, and each preset service element may be a field corresponding to the preset service entry page, for example, the preset service entry page may include an element name and an element input region of the preset service element corresponding to the target service type. After accessing the preset service entry page, the service provider may input, in the preset service entry page, the element content corresponding to the preset service element. The service information of the target service entered by the service provider based on the preset service entry page is determined according to the element content, and the service information is recorded as the initial service information. Specifically, the service provider may refer to the element name to input the element content that is desired to be set in the corresponding element input region. As described in the foregoing example, assuming that a current service provider is a photography studio, and the target service is a wedding photography service and the target service type is a photography service, the element name of the preset service element that may be displayed in the preset service entry page is, for example, “shooting city”. The element input region is associated with a display region where the element name is located. For example, the element input region is located below the display region where the element name is located. The service provider may input a specific shooting city, such as “City A”, in the element input region according to an actual service content, and then the initial service information includes an element content “City A” corresponding to “shooting city”.

Step 102: performing information detection on the initial service information, and when a detection result of the initial service information is passing, creating at least one initial service page according to the initial service information.

In the embodiments of the present disclosure, when performing information detection on the initial service information, a specific detection item involved may be set according to an actual requirement, and a detection manner may include machine detection and/or manual detection, which is not specifically limited. As described in the foregoing example, it may be detected whether the package name includes a sensitive word, whether the package price exceeds a preset range, whether the shooting city is incorrectly input, and the like. When it is determined that the information detection is performed on the initial service information and the detection result is passing, then the initial service page may be created according to the initial service information.

It should be noted that after the detection result of the initial service information is determined to be passing, the initial service page may be created immediately, or the initial service information that has been detected may be stored, and when the service page needs to be generated, the initial service information of which the detection result is passing may be acquired to create the initial service page.

Exemplarily, there may be one or more initial service pages, which may be understood as preliminarily generated service pages to be detected. A specific creation manner of the initial service page is not limited, and the initial service page may be automatically created by a preset network platform according to the initial service information. Alternatively, the detection result may be fed back to the service provider, so that the service provider can develop a page based on the initial service information that has passed the detection, so as to create the initial service page. Alternatively, after the preset network platform automatically creates the initial service page according to the initial service information, an original service page created automatically may be provided to the service provider, and the service provider may edit the original service page to obtain the initial service page.

Step 103: performing page style detection on the at least one initial service page, and determining an initial service page of which a detection result is passing, in the at least one initial service page, as a target service page corresponding to the target service, where the target service page is a page used for being displayed in a preset network platform.

In the embodiments of the present disclosure, after the initial service page is acquired, because the service information included in the initial service page has been pre-detected, in response to no newly added service information, then there is no need to perform service information detection, and the page style detection is directly performed. When performing the page style detection on the initial service page, a specific detection item involved may be set according to an actual requirement, and the detection manner may include machine detection and/or manual detection, which is not specifically limited. The detection item of the page style detection may include, for example, whether the styles such as text (such as a promotional term) and a graphic (such as a border and a background color) in the page satisfy a preset style requirement, whether text content and image content satisfy a preset content requirement, and the detection item may also include related items such as page aesthetics, etc. In response to a plurality of initial service pages, the page style detection may be performed on each initial service page in turn.

Exemplarily, when it is determined that the initial service page has passed the page style detection, and the detection result is passing, then the initial service page may be determined as the service page corresponding to the target service and used for being displayed in the preset network platform, that is, the target service page. When there are a plurality of initial service pages, in response to each initial service page of the plurality of initial service pages having a passing detection result of the page style detection, then a plurality of target service pages may be determined, that is, the number of the target service pages is the same as the number of the initial service pages at this time. In response to some of the plurality of initial service pages having a passing detection result of the page style detection, then the initial service pages that have passed the detection may be determined as the target service pages, that is, the number of the target service pages is less than the number of the initial service pages at this time.

Optionally, a number of the target service pages is more than one, and different target service pages are used for being displayed in different display scenarios in the preset network platform. Different display scenarios may correspond to traffic from different channels of the target service pages, or may also correspond to the display in different functions. For example, in a media content display function, a target service page a may be a service page displayed on an upper layer of a media content display page (a size of the target service page a may be smaller than the size of the media content display page). In a search function, a target service page b may be a sub-page in a search result aggregation page displayed after a user inputs a search operation, or a service details page that the user jumps to after triggering a search result item in the search result aggregation page. The page styles of the target service page a and the target service page b may be different, so as to satisfy service requirements in different display scenarios.

In the page processing method provided by the embodiments of the present disclosure, the initial service information of the target service based on the preset service entry page is acquired, the preset service entry page includes the preset service element corresponding to the target service type, and the initial service information includes the element content corresponding to the preset service element. When the information detection is performed on the initial service information and the information detection is passed, the at least one initial service page is created according to the initial service information, the page style detection is performed on the at least one initial service page, and the initial service page of which the detection result is passing in the at least one initial service page is determined as the target service page corresponding to the target service, where the target service page is used for being displayed in the preset network platform. By using the foregoing technical solution, the service information detection and the page style detection for the service page are separated, the pre-detection is performed on the service information, after the pre-detection is passed, at least one corresponding initial service page to be detected is created, and then the page style detection is performed, so that the detection for the service page can be more flexible and efficient, and when there is a need to create a plurality of target service pages, operations of repeatedly detecting the service information can be effectively reduced, the page detection efficiency is improved, and then timeliness of displaying the target service page in the preset network platform is improved.

In some embodiments, creating at least one initial service page according to the initial service information includes: acquiring a page template set corresponding to the target service type, where the page template set includes at least one page template; and for each page template in the page template set, when a template service element included in a current page template is determined as a subset of the preset service element, creating a corresponding initial service page according to the initial service information and the current page template. Therefore, the initial service page is created according to the initial service information and the page template, which can improve the creation efficiency of the initial service page and further improve the timeliness of displaying the target service page.

Optionally, the page template is a preset template and/or a template obtained by performing modification on the preset template. Therefore, the flexibility of using the template can be improved, and both the page generation efficiency and the personalized requirements of the service provider for the service page can be considered.

Exemplarily, one or more page templates (recorded as preset templates) may be designed in advance according to characteristics of the target service type, so as to automatically create corresponding initial service pages by using the preset templates. When there are a plurality of preset templates, different preset templates may correspond to different template styles. Optionally, differences in the template styles may be reflected in a page size, a page display mode (such as a full-screen display mode, a half-screen display mode, or a floating window display mode), the number of page components, types of the page components, a layout of the page components, and the like.

Exemplarily, the template obtained by performing modification on the preset template may be recorded as a service provider's custom template. The service provider may perform modification on the preset template provided by the preset network platform, for example, modifying the page size, adding a page component, modifying the types of the page components, and modifying the layout of the page components.

Exemplarily, the page template set may be understood as a set of page templates that the service provider currently needs to use, and the page template set may include one or more page templates. Optionally, when creating the initial service page, the service provider may access a preset template library corresponding to the target service type, and select one or more templates from the preset template library. The page template set includes the template selected by the service provider. The preset template library may include a preset template, and may also include a service provider's custom template created historically. After the service provider select a certain preset template, the service provider may also be supported to edit the preset template to generate a new service provider's custom template, and add the new service provider's custom template to the preset template library to update the preset template library. Exemplarily, the corresponding initial service page may be created according to the page templates in the page template set individually or in batch in parallel. The service element included in the page template may be recorded as the template service element. Because there are differences between different page templates, the template service elements included in different page templates may also be different, and the service provider may not select all the templates corresponding to the target service type when selecting the page template. Therefore, in order to improve the efficiency of entering service information, all template service elements may be prevented from being set as the preset service elements, and the template service element with strong universality may be set as the preset service element. For example, the page template A includes a service main title, a service category and a service tag, the page template B includes a service main title, a service sub-title, a service category, and a place where a service is provided, and the page template C includes a service main title and a service category. The preset service elements may include a service main title and a service category. For the page template C, the template service element is a subset of the preset service elements, and the corresponding initial service page may be directly created according to the initial service information and the page template C, so as to improve the creation efficiency of pages.

Exemplarily, the element content included in the initial service information may be filled into a corresponding template service element in the current page template according to a configuration of the current page template, so as to create a corresponding initial service page. For example, the current page template includes a package name, and the package name is text content of a page element, and the package name included in the initial service information may be set as a value of a field corresponding to the text content of the page element.

In some embodiments, the method further includes: for the current page template, when the template service element is determined to include an incremental service element, acquiring incremental service information, where the incremental service information includes an element content corresponding to the incremental service element, and the incremental service element is a service element different from the preset service element in the template service element; and performing information detection on the incremental service information, and when a detection result of the incremental service information is passing, creating a corresponding initial service page according to the initial service information, the incremental service information and the current page template. Therefore, the page generation efficiency can be further considered and the personalized requirements of the service provider for the service page can be satisfied.

Exemplarily, as described above, there are differences between different page templates, and template service elements included in different page templates may also be different. The preset service elements may not cover all the template service elements. For a certain page template, a certain template service element of the page template may not exist in the preset service elements, that is, the service provider does not enter a corresponding element content based on the preset service entry page, and a service element that is different from the preset service element in the template service elements is recorded as an incremental service element. In this case, the incremental service information may be acquired, the incremental service information includes the element content corresponding to the incremental service element, and the information detection is performed on the incremental service information. The detection item in this case may be the same as or different from the detection item when the information detection is performed on the initial service information, which may be set according to an actual requirement. When the detection result of the incremental service information is passing, both the initial service information and the incremental service information have passed the detection, and the corresponding initial service page may be created according to the initial service information, the incremental service information and the current page template.

In some embodiments, after the determining an initial service page of which a detection result is passing, in the at least one initial service page, as a target service page corresponding to the target service, the method further includes: acquiring change service information, where the change service information includes change information of a target service element in the target service page; and performing information detection on the change service information, and when a detection result of the change service information is passing, updating an element content of the target service element in the target service page according to the service change information. Therefore, when it is required to modify the service element in the generated target service page, the modified element content may be detected to reduce the operation of the page style detection, so that the modified element content can be quickly, safely and dynamically applied to the corresponding target service page, which improving the page iteration efficiency, and reducing the impact on the display of the online service page.

Exemplarily, the target service element is a service element included in the target service page, may specifically include the preset service element, and may also include the incremental service element. When there are a plurality of the target service pages, the target service element may be a service element included in all or part of the target service pages. For example, it is assumed that the package name needs to be modified, and each of the target service pages includes the package name. Taking two target service pages as an example, the two target service pages are recorded as a target service page a and a target service page b, respectively. The change service information may be the modified package name, for example, the package name is modified from the package AAA to the package BBB, and the change information may include the package BBB, and the package BBB may be applied to the target service page a and the target service page b. For another example, it is assumed that the service tag needs to be modified, the target service page includes the service tag, and the target service page b does not include the service tag. The change service information may be the modified service tag, for example, the service tag is modified from the tag CCC to the tag DDD, and the change information may include the tag DDD, and the tag DDD may be applied to the target service page a.

In some embodiments, the target service is associated with service information sets of a plurality of versions that have passed the information detection, and the service information sets at least include the initial service information; and after determining an initial service page of which a detection result is passing, in the at least one initial service page, as a target service page corresponding to the target service, the method further includes: in response to a service information version switching operation, switching an element content corresponding to a page service element in the target service page from an element content in a service information set of the first version to an element content in a service information set of the second version, where the page service element at least includes the preset service element. Therefore, the service information of the plurality of versions corresponding to the service may be supported to be maintained, and the service provider can quickly switch the element content according to an actual service requirement, so that the efficiency of applying the service page is improved.

Exemplarily, the service information sets at least include the initial service information, and may also include the incremental service information. Optionally, in response to there being change service information, the service information before change and the service information after change may belong to different service information sets. The service information set of the first version may be understood as the service information set of the version corresponding to the currently used target service page, and the service information set of the second version may be understood as the service information set of the version corresponding to the to-be-used target service page. When the version switching is required, element contents of a plurality of service elements in the same target service page may be switched in batch, so as to further improve timeliness of applying the service page. In addition, when there are a plurality of the target service pages, element contents in the plurality of the target service pages may be synchronously replaced in batch, so as to further improve timeliness of applying the service page.

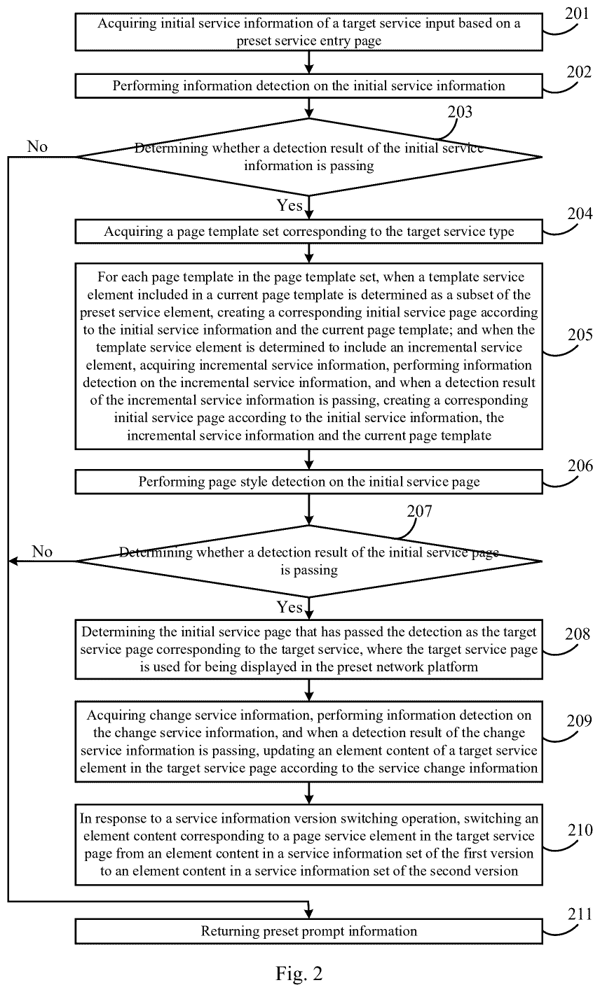

FIG. 2 is a flowchart of another page processing method provided by an embodiment of the present disclosure. The embodiments of the present disclosure are optimized based on various optional solutions in the foregoing embodiments. Specifically, the method includes the following steps.

Step 201: acquiring initial service information of a target service input based on a preset service entry page.

The preset service entry page includes a preset service element corresponding to a target service type, and the initial service information includes an element content corresponding to the preset service element.

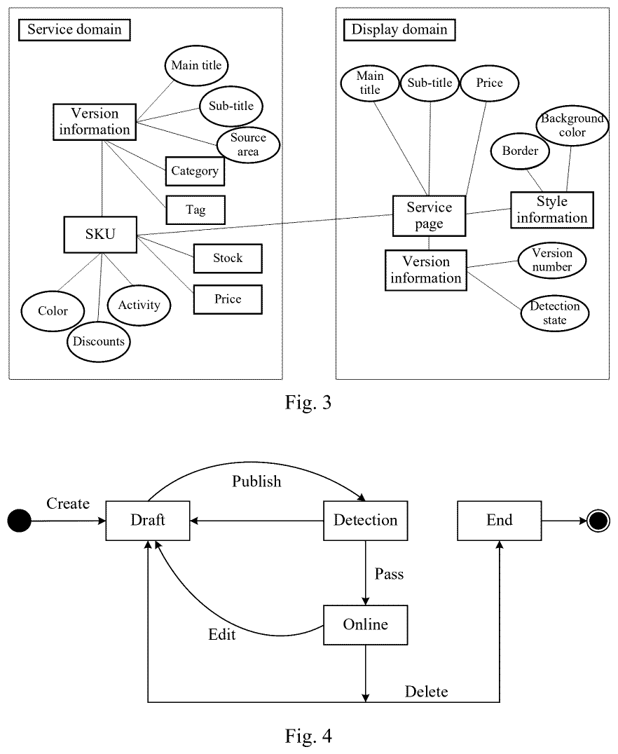

FIG. 3 is a schematic diagram of service modeling provided by an embodiment of the present disclosure. As shown in FIG. 3, the service model includes a service domain and a display domain. The service domain mainly relates to service information, such as a product service. The service elements associated with service domain include a main title, a sub-title, a source area, a category, and a tag. For a product, there may be N stock keeping units (SKUs), and the SKUs are further associated with a color, discounts, an activity, a stock, and a price. Each SKU may correspond to M service pages in the display domain. In the display domain, the main title, the sub-title, the price, and the like need to be displayed in the service page, and the style information of the service page may include a border, a background color, and the like. In addition, the service is associated with service information sets of a plurality of versions, and the service information set of each version may maintain a corresponding version number and a detection state (such as whether the detection has been passed).

Optionally, the service information sets of different versions may be managed in the form of a version stack, so as to improve the management efficiency. For the service information set of each version, an SKU name (such as a decoration package E), a page header image (such as a renderings about the decoration package E displayed on the top of the service page) and other service information may be stored, and the detection state, such as a status code and detection comment information (such as an aesthetic score or description of the page header image), may also be stored in association.

Step 202: performing information detection on the initial service information.

Step 203: determining whether a detection result of the initial service information is passing; if yes, performing the step 204; if not, performing the step 211.

Exemplarily, the service information may be managed by using a state machine. FIG. 4 is a schematic diagram of a state machine provided by an embodiment of the present disclosure. The initial service information recorded (created) by the service provider for the first time is in a draft state, and the information detection is performed on the initial service information after the initial service information is published. In response to the detection being passed, the initial service information may jump to an allowed to be delivered (online state); in response to the detection being not passed, the initial service information is rejected to be delivered and returns to the draft state. In response to the initial service information being edited after being delivered, the initial service information returns to the draft state, and the information detection is performed on the initial service information again after the initial service information is published. In response to the detection being passed, the initial service information is online. In response to the initial service information being online or the draft state being deleted, the initial service information jumps to an end state.

Step 204: acquiring a page template set corresponding to the target service type.

Exemplarily, the page template set includes a plurality of page templates, and the plurality of page templates include a preset template and/or a template obtained by performing modification on the preset template, so that the plurality of page templates may be used for subsequent batch creation of the initial service page, and then a plurality of target service pages of different styles are generated and used for being displayed in different display scenarios in the preset network platform.

Step 205: for each page template in the page template set, when a template service element included in a current page template is determined as a subset of the preset service element, creating a corresponding initial service page according to the initial service information and the current page template; and when the template service element is determined to include an incremental service element, acquiring incremental service information, performing information detection on the incremental service information, and when a detection result of the incremental service information is passing, creating a corresponding initial service page according to the initial service information, the incremental service information and the current page template.

Step 206: performing page style detection on the initial service page.

Step 207: determining whether a detection result of the initial service page is passing; if yes, performing the step 208; if not, performing the step 211.

Step 208: determining the initial service page that has passed the detection as the target service page corresponding to the target service, where the target service page is used for being displayed in the preset network platform.

Step 209: acquiring change service information, performing information detection on the change service information, and when a detection result of the change service information is passing, updating an element content of a target service element in the target service page according to the service change information.

Step 210: in response to a service information version switching operation, switching an element content corresponding to a page service element in the target service page from an element content in a service information set of the first version to an element content in a service information set of the second version.

Step 211: returning preset prompt information.

Exemplarily, in response to the detection result of the service information being not passing, or the detection result of the page style being not passing, the preset prompt information may be returned. The preset prompt information is used to prompt the service provider that the detection is not passed, the preset prompt information may specifically include a conclusion that the detection is not passed, and may also include a specific reason why the detection is not passed, so that the service provider can quickly perform relevant processing and re-initiate the detection.

In the page processing method provided by the embodiments of the present disclosure, the service information detection and the page style detection for the service page are separated, the pre-detection is performed on the service information, after the detection is passed, a plurality of initial service pages of different styles to be detected are created by using the page template, and then the page style detection is performed, so that the detection for the service page can be more flexible and efficient, operations of repeatedly detecting the service information can be effectively reduced, the page detection efficiency is improved, and then timeliness of displaying the target service page in the preset network platform is improved. Moreover, the dynamic modification on the service element is supported. The modified element content is detected, and the service information and page style that have been detected may not need to be detected, so that the modified element content can be quickly, safely and dynamically applied to the corresponding target service page. In addition, service information of a plurality of versions corresponding to the service may be supported to be maintained, which is convenient for the service provider to quickly switch the element content according to an actual service requirement, effectively improves the page iteration efficiency, and reduces the impact on the display of the online service page.

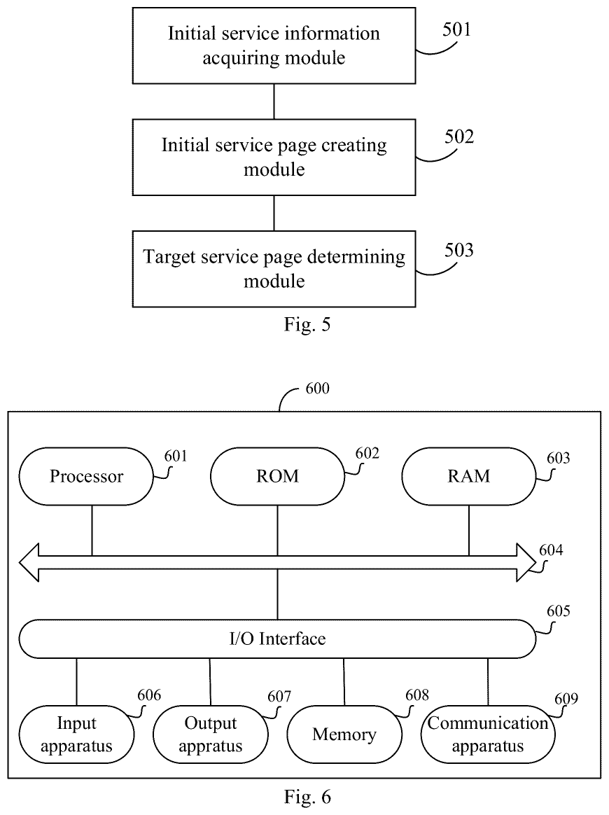

FIG. 5 is a structural diagram of a page processing apparatus provided by an embodiment of the present disclosure. As shown in FIG. 5, the apparatus includes an initial service information acquiring module 501, an initial service page creating module 502, and a target service page determining module 503.

The initial service information acquiring module 501 is configured to acquire initial service information of a target service input based on a preset service entry page, where the preset service entry page includes a preset service element corresponding to a target service type, a type of the target service is the target service type, and the initial service information includes an element content corresponding to the preset service element.

The initial service page creating module 502 is configured to perform information detection on the initial service information, and when a detection result of the initial service information is passing, create at least one initial service page according to the initial service information.

The target service page determining module 503 is configured to perform page style detection on the at least one initial service page, and determine an initial service page of which a detection result is passing, in the at least one initial service page, as a target service page corresponding to the target service, where the target service page is a page used for being displayed in a preset network platform.

The page processing apparatus provided by the embodiments of the present disclosure separates the service information detection and the page style detection of the service page, performs the pre-detection on the service information, creates the at least one corresponding initial service page to be detected is created after the detection is passed, and then performs page style detection, so that the detection for the service page can be more flexible and efficient, and when there is a need to create a plurality of target service pages, operations of repeatedly detecting the service information can be effectively reduced, the page detection efficiency is improved, and then timeliness of displaying the target service page in the preset network platform is improved.

Optionally, the initial service page creating module includes an information detection sub-module and an initial service page creation sub-module.

The information detecting sub-module is configured to perform information detection on the initial service information.

The initial service page creating sub-module is configured to, when a detection result of the initial service information is passing, create the at least one initial service page according to the initial service information.

The initial service page creating sub-module includes a page template set acquiring unit and the first creation unit.

The page template set acquiring unit is configured to, when the detection result of the initial service information is passing, acquire a page template set corresponding to the target service type, where the page template set includes at least one page template.

The first creation unit is configured to, for each page template in the page template set, when a template service element included in a current page template is determined as a subset of the preset service element, create a corresponding initial service page according to the initial service information and the current page template.

Optionally, the initial service page creation sub-module further includes an incremental service information acquiring unit and the second creation unit.

The incremental service information acquiring unit is configured to, for the current page template, when the template service element is determined to include an incremental service element, acquire incremental service information, where the incremental service information includes an element content corresponding to the incremental service element, and the incremental service element is a service element different from the preset service element in the template service element.

The second creation unit is configured to perform information detection on the incremental service information, and when a detection result of the incremental service information is passing, create a corresponding initial service page according to the initial service information, the incremental service information and the current page template.

Optionally, the page template is a preset template and/or a template obtained by performing modification on the preset template.

Optionally, the apparatus further includes a change service information acquiring module and an element content updating module.

The change service information acquiring module is configured to: after determining an initial service page of which a detection result is passing, in the at least one initial service page, as a target service page corresponding to the target service, acquire change service information, where the change service information includes change information of a target service element in the target service page.

The element content updating module is configured to perform information detection on the change service information, and when a detection result of the change service information is passing, update an element content of the target service element in the target service page according to the service change information.

Optionally, the target service is associated with service information sets of a plurality of versions that have passed the information detection, and the service information sets at least include the initial service information.

The apparatus further includes a switching module.

The switching module is configured to: after determining an initial service page of which a detection result is passing, in the at least one initial service page, as a target service page corresponding to the target service, in response to a service information version switching operation, switch an element content corresponding to a page service element in the target service page from an element content in a service information set of the first version to an element content in a service information set of the second version, where the page service element at least includes the preset service element.

Optionally, a plurality of the target service pages are used for being displayed in different display scenarios in the preset network platform.

The page processing apparatus provided by the embodiments of the present disclosure can perform the page processing method provided by any embodiment of the present disclosure, and has functional modules and beneficial effects corresponding to performing the method.

It should be noted that the units and modules included in the foregoing apparatus are just divided according to functional logic, but are not limited to the foregoing division, as long as the corresponding functions can be implemented. In addition, the specific names of the functional units are only for distinguishing between each other, and are not intended to limit the protection scope of the embodiments of the present disclosure.

FIG. 6 is a structural diagram of an electronic device according to an embodiment of the present disclosure. Reference is made to FIG. 6 below, which illustrates a structural diagram of an electronic device 600 (such as a terminal device or a server in FIG. 6) suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a tablet computer, a portable media player (PMP), and a vehicle-mounted terminal (such as a vehicle navigation terminal), and a stationary terminal such as a digital TV and a desktop computer. The electronic device shown in FIG. 6 is merely an example, and should not impose any limitation on the functions and scope of use of the embodiments of the present disclosure.

As shown in FIG. 6, the electronic device 600 may include a processor (such as a central processing unit and a graphics processing unit) 601. The processor 601 may perform various appropriate actions and processing according to a program stored in a read-only memory (ROM) 602 or a program loaded from a memory 608 into a random-access memory (RAM) 603. The RAM 603 further stores various programs and data required for the operation of the electronic device 600. The processor 601, the ROM 602, and the RAM 603 are connected to each other through a bus 604. An edit/output (I/O) interface 605 is also connected to the bus 604.

Generally, the following apparatus may be connected to the I/O interface 605: an input apparatus 606 such as a touchscreen, a touchpad, a keyboard, a mouse, a camera, a microphone, an accelerometer, and a gyroscope; an output apparatus 607 such as a liquid crystal display (LCD), a speaker, and a vibrator; the memory 608 such as a magnetic tape and a hard disk; and a communication apparatus 609. The communication apparatus 609 may allow the electronic device 600 to perform wireless or wired communication with other devices to exchange data. While FIG. 6 shows the electronic device 600 having various apparatuses, it should be understood that not all the illustrated apparatuses are required to be implemented or present. Alternatively, more or fewer apparatuses may be implemented or present.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, and the computer program includes program code for executing the method shown in the flowchart. In such embodiments, the computer program may be downloaded and installed from the network through the communication apparatus 609, or may be installed from the memory 608, or may be installed from the ROM 602. When the computer program is executed by the processor 601, the above functions defined in the methods of the embodiments of the present disclosure are performed.

The names of messages or information exchanged between apparatuses in the implementations of the present disclosure are only for illustrative purposes, and are not intended to limit the scope of these messages or information.

The electronic device provided by the embodiments of the present disclosure and the page processing method provided by the foregoing embodiments belong to the same inventive concept. For technical details that are not described in detail in this embodiment, reference may be made to the foregoing embodiments, and this embodiment has the same beneficial effects as the foregoing embodiments.

Embodiments of the present disclosure provide a computer storage medium, which stores a computer program. When the program is executed by a processor, the processor performs the page processing method according to the foregoing embodiments.

Embodiments of the present disclosure provide a computer program product including a computer program. When the program is executed by a processor, the processor performs the page processing method according to the foregoing embodiments.

It should be noted that the foregoing computer-readable medium in the present disclosure may be a computer-readable signal medium or a computer-readable storage medium, or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to, an electrical connection having one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. In the present disclosure, the computer-readable signal medium may include a data signal propagated in a baseband or as part of a carrier wave, in which a computer-readable program code is carried. This propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may transmit, propagate, or transmit a program for use by or in combination with an instruction execution system, apparatus, or device. The program code included on the computer-readable medium may be transmitted by any suitable medium, including but not limited to an electric wire, an optical cable, radio frequency (RF), or any suitable combination thereof.

The foregoing computer-readable medium may be included in the foregoing electronic device, or may exist independently without being assembled into the electronic device.

The foregoing computer-readable medium carries one or more programs, and when the one or more programs are executed by the electronic device, the electronic device is caused to: acquire initial service information of a target service input based on a preset service entry page, where the preset service entry page includes a preset service element corresponding to a target service type, a type of the target service is the target service type, and the initial service information includes an element content corresponding to the preset service element; perform information detection on the initial service information, and when a detection result of the initial service information is passing, create at least one initial service page according to the initial service information; and perform page style detection on the at least one initial service page, and determine an initial service page of which a detection result is passing, in the at least one initial service page, as a target service page corresponding to the target service, where the target service page is a page used for being displayed in a preset network platform.

The computer program code for performing the operations of the present disclosure may be written in one or more programming languages or a combination thereof. The foregoing programming languages include, but are not limited to, object-oriented programming languages such as Java, Smalltalk, and C++, and also include conventional procedural programming languages such as the “C” programming language or similar programming languages. The program code may be executed entirely on a user's computer, partly on a user's computer, as an independent software package, partly on a user's computer and partly on a remote computer, or entirely on a remote computer or a server. In the case of the remote computer, the remote computer may be connected to the user's computer through any type of network, including a local area network (LAN) or a wide area network (WAN), or may be connected to an external computer (for example, via the Internet through an Internet service provider).

The flowcharts and block diagrams in the drawings show possible architectures, functions and operations of the system, method and computer program product according to various embodiments of the present disclosure. In this regard, each block in the flowchart or block diagram may represent a module, a program segment, or a part of code, and the module, program segment, or part of code includes one or more executable instructions for implementing the specified logical function. It should also be noted that, in some alternative implementations, the functions marked in the blocks may also occur in a different order than the order marked in the drawings. For example, two blocks shown one after another may actually be executed substantially in parallel, and they may sometimes be executed in the reverse order, depending on the functions involved. It should also be noted that each block in the block diagram and/or flowchart, and the combination of blocks in the block diagram and/or flowchart, may be implemented by a dedicated hardware-based system that performs the specified functions or operations, or may be implemented by a combination of dedicated hardware and computer instructions.

The units involved in the embodiments of the present disclosure may be implemented in software or hardware. Among them, the name of a module does not constitute a limitation on the module itself under certain circumstances. For example, the initial service page creating module may also be described as “a module for performing information detection on the initial service information, and when the detection result of the initial service information is passing, creating at least one initial service page according to the initial service information”.

The functions described above herein may be at least partially performed by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logic device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, a page processing method is provided, including:
acquiring initial service information of a target service input based on a preset service entry page, where the preset service entry page includes a preset service element corresponding to a target service type, a type of the target service is the target service type, and the initial service information includes an element content corresponding to the preset service element;
performing information detection on the initial service information, and when a detection result of the initial service information is passing, creating at least one initial service page according to the initial service information; and
performing page style detection on the at least one initial service page, and determining an initial service page of which a detection result is passing, in the at least one initial service page, as a target service page corresponding to the target service, wherein the target service page is a page used for being displayed in a preset network platform.

According to one or more embodiments of the present disclosure, the creating the at least one initial service page according to the initial service information includes:
acquiring a page template set corresponding to the target service type, where the page template set includes at least one page template; and
for each page template in the page template set, when a template service element included in a current page template is determined as a subset of the preset service element, creating a corresponding initial service page according to the initial service information and the current page template.

According to one or more embodiments of the present disclosure, the method further includes:
for the current page template, when the template service element is determined to comprise an incremental service element, acquiring incremental service information, where the incremental service information includes an element content corresponding to the incremental service element, and the incremental service element is a service element different from the preset service element in the template service element; and
performing information detection on the incremental service information, and when a detection result of the incremental service information is passing, creating a corresponding initial service page according to the initial service information, the incremental service information, and the current page template.

According to one or more embodiments of the present disclosure, the page template is a preset template and/or a template obtained by performing modification on the preset template.

According to one or more embodiments of the present disclosure, after the determining an initial service page of which a detection result is passing, in the at least one initial service page, as a target service page corresponding to the target service, the method further includes:
acquiring change service information, where the change service information includes change information of a target service element in the target service page; and
performing information detection on the change service information, and when a detection result of the change service information is passing, updating an element content of the target service element in the target service page according to the service change information.

According to one or more embodiments of the present disclosure, the target service is associated with service information sets of a plurality of versions that have passed the information detection, and the service information sets at least include the initial service information; and after the determining an initial service page of which a detection result is passing, in the at least one initial service page, as a target service page corresponding to the target service, the method further includes:
in response to a service information version switching operation, switching an element content corresponding to a page service element in the target service page from an element content in a service information set of the first version to an element content in a service information set of the second version, where the page service element at least includes the preset service element.

According to one or more embodiments of the present disclosure, a number of the target service pages is more than one, and different target service pages are used for being displayed in different display scenarios in the preset network platform.

According to one or more embodiments of the present disclosure, a page processing apparatus is provided, and includes an initial service information acquiring module, an initial service page creating module and a target service page determining module.

The initial service information acquiring module is configured to acquire initial service information of a target service input based on a preset service entry page, where the preset service entry page includes a preset service element corresponding to a target service type, a type of the target service is the target service type, and the initial service information includes an element content corresponding to the preset service element.

The initial service page creating module is configured to perform information detection on the initial service information, and when a detection result of the initial service information is passing, create at least one initial service page according to the initial service information.

The target service page determining module is configured to perform page style detection on the at least one initial service page, and determine an initial service page of which a detection result is passing, in the at least one initial service page, as a target service page corresponding to the target service, wherein the target service page is a page used for being displayed in a preset network platform.

According to one or more embodiments of the present disclosure, an electronic device is provided. The electronic device includes one or more processors, and a memory.

The memory is configured to store one or more programs,

When the one or more programs are executed by the one or more processors, the one or more processors is caused to implement the page processing method provided by the embodiments of the present disclosure.

According to one or more embodiments of the present disclosure, a storage medium including computer-executable instructions is provided. When the computer-executable instructions are executed by a computer processor, the computer-executable instructions are used for executing the page processing method provided by the embodiments of the present disclosure.

The above description is only a preferred embodiment of the present disclosure and an illustration of the technical principles used. Those skilled in the art should understand that the scope of disclosure involved in the present disclosure is not limited to the technical solutions formed by the specific combination of the above technical features, but also covers other technical solutions formed by any combination of the above technical features or their equivalent features without departing from the above disclosure concept, such as the technical solutions formed by replacing the above features with the technical features with similar functions disclosed in the present disclosure (but not limited to).

In addition, although the operations are described in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are only example forms for implementing the claims.

1. A page processing method, comprising:
acquiring initial service information of a target service input based on a preset service entry page, wherein the preset service entry page comprises a preset service element corresponding to a target service type, a type of the target service is the target service type, and the initial service information comprises an element content corresponding to the preset service element;
performing information detection on the initial service information, and when a detection result of the initial service information is passing, creating at least one initial service page according to the initial service information; and
performing page style detection on the at least one initial service page, and determining an initial service page of which a detection result is passing, in the at least one initial service page, as a target service page corresponding to the target service, wherein the target service page is a page used for being displayed in a preset network platform.

2. The method of claim 1, wherein the creating at least one initial service page according to the initial service information comprises:
acquiring a page template set corresponding to the target service type, wherein the page template set comprises at least one page template; and
for each page template in the page template set, when a template service element comprised in a current page template is determined as a subset of the preset service element, creating a corresponding initial service page according to the initial service information and the current page template.

3. The method of claim 2, further comprising:
for the current page template, when the template service element is determined to comprise an incremental service element, acquiring incremental service information, wherein the incremental service information comprises an element content corresponding to the incremental service element, and the incremental service element is a service element different from the preset service element in the template service element; and
performing information detection on the incremental service information, and when a detection result of the incremental service information is passing, creating a corresponding initial service page according to the initial service information, the incremental service information and the current page template.

4. The method of claim 2, wherein the page template is a preset template and/or a template obtained by performing modification on the preset template.

5. The method of claim 1, wherein after the determining an initial service page of which a detection result is passing, in the at least one initial service page, as a target service page corresponding to the target service, the method further comprises:
acquiring change service information, wherein the change service information comprises change information of a target service element in the target service page; and
performing information detection on the change service information, and when a detection result of the change service information is passing, updating an element content of the target service element in the target service page according to the service change information.

6. The method of claim 1, wherein the target service is associated with service information sets of a plurality of versions that have passed the information detection, and the service information sets at least comprise the initial service information; and after the determining an initial service page of which a detection result is passing, in the at least one initial service page, as a target service page corresponding to the target service, the method further comprises:
in response to a service information version switching operation, switching an element content corresponding to a page service element in the target service page from an element content in a service information set of a first version to an element content in a service information set of a second version, wherein the page service element at least comprises the preset service element.

7. The method of claim 1, wherein a number of the target service pages is more than one, and different target service pages are used for being displayed in different display scenarios in the preset network platform.

8. An electronic device, comprising:
one or more processors; and
a memory, configured to store one or more programs,
wherein when the one or more programs are executed by the one or more processors, the one or more processors is caused to implement a page processing method, and the page processing method comprises:
acquiring initial service information of a target service input based on a preset service entry page, wherein the preset service entry page comprises a preset service element corresponding to a target service type, a type of the target service is the target service type, and the initial service information comprises an element content corresponding to the preset service element;
performing information detection on the initial service information, and when a detection result of the initial service information is passing, creating at least one initial service page according to the initial service information; and
performing page style detection on the at least one initial service page, and determining an initial service page of which a detection result is passing, in the at least one initial service page, as a target service page corresponding to the target service, wherein the target service page is a page used for being displayed in a preset network platform.

9. The electronic device of claim 8, wherein the creating at least one initial service page according to the initial service information comprises:
acquiring a page template set corresponding to the target service type, wherein the page template set comprises at least one page template; and
for each page template in the page template set, when a template service element comprised in a current page template is determined as a subset of the preset service element, creating a corresponding initial service page according to the initial service information and the current page template.

10. The electronic device of claim 9, wherein the page processing method further comprises:
for the current page template, when the template service element is determined to comprise an incremental service element, acquiring incremental service information, wherein the incremental service information comprises an element content corresponding to the incremental service element, and the incremental service element is a service element different from the preset service element in the template service element; and
performing information detection on the incremental service information, and when a detection result of the incremental service information is passing, creating a corresponding initial service page according to the initial service information, the incremental service information and the current page template.

11. The electronic device of claim 9, wherein the page template is a preset template and/or a template obtained by performing modification on the preset template.

12. The electronic device of claim 8, wherein after the determining an initial service page of which a detection result is passing, in the at least one initial service page, as a target service page corresponding to the target service, the method further comprises:
acquiring change service information, wherein the change service information comprises change information of a target service element in the target service page; and
performing information detection on the change service information, and when a detection result of the change service information is passing, updating an element content of the target service element in the target service page according to the service change information.

13. The electronic device of claim 8, wherein the target service is associated with service information sets of a plurality of versions that have passed the information detection, and the service information sets at least comprise the initial service information; and after the determining an initial service page of which a detection result is passing, in the at least one initial service page, as a target service page corresponding to the target service, the method further comprises:
in response to a service information version switching operation, switching an element content corresponding to a page service element in the target service page from an element content in a service information set of a first version to an element content in a service information set of a second version, wherein the page service element at least comprises the preset service element.

14. The electronic device of claim 8, wherein a number of the target service pages is more than one, and different target service pages are used for being displayed in different display scenarios in the preset network platform.

15. A non-transient storage medium, comprising computer-executable instructions, wherein when the computer-executable instructions are executed by a computer processor, the computer-executable instructions are used for executing a page processing method, and the page processing method comprises:
acquiring initial service information of a target service input based on a preset service entry page, wherein the preset service entry page comprises a preset service element corresponding to a target service type, a type of the target service is the target service type, and the initial service information comprises an element content corresponding to the preset service element;
performing information detection on the initial service information, and when a detection result of the initial service information is passing, creating at least one initial service page according to the initial service information; and
performing page style detection on the at least one initial service page, and determining an initial service page of which a detection result is passing, in the at least one initial service page, as a target service page corresponding to the target service, wherein the target service page is a page used for being displayed in a preset network platform.

16. The non-transient storage medium of claim 15, wherein the creating at least one initial service page according to the initial service information comprises:
acquiring a page template set corresponding to the target service type, wherein the page template set comprises at least one page template; and
for each page template in the page template set, when a template service element comprised in a current page template is determined as a subset of the preset service element, creating a corresponding initial service page according to the initial service information and the current page template.

17. The non-transient storage medium of claim 16, wherein the page processing method further comprises:
for the current page template, when the template service element is determined to comprise an incremental service element, acquiring incremental service information, wherein the incremental service information comprises an element content corresponding to the incremental service element, and the incremental service element is a service element different from the preset service element in the template service element; and
performing information detection on the incremental service information, and when a detection result of the incremental service information is passing, creating a corresponding initial service page according to the initial service information, the incremental service information and the current page template.

18. The non-transient storage medium of claim 16, wherein the page template is a preset template and/or a template obtained by performing modification on the preset template.

19. The non-transient storage medium of claim 15, wherein after the determining an initial service page of which a detection result is passing, in the at least one initial service page, as a target service page corresponding to the target service, the method further comprises:
acquiring change service information, wherein the change service information comprises change information of a target service element in the target service page; and
performing information detection on the change service information, and when a detection result of the change service information is passing, updating an element content of the target service element in the target service page according to the service change information.

20. The non-transient storage medium of claim 15, wherein the target service is associated with service information sets of a plurality of versions that have passed the information detection, and the service information sets at least comprise the initial service information; and after the determining an initial service page of which a detection result is passing, in the at least one initial service page, as a target service page corresponding to the target service, the method further comprises:
in response to a service information version switching operation, switching an element content corresponding to a page service element in the target service page from an element content in a service information set of a first version to an element content in a service information set of a second version, wherein the page service element at least comprises the preset service element.
